(19) United States
(12) Patent Application Publication
(10) Pub. No.: US 2007/0256838 A1
(43) Pub. Date: Nov. 8, 2007

(54) Fracturing fluids for use in oil and gas recovery operations

(75) Inventors: C. Edward Baxter, League City, TX (US); Sam Wernli, Houston, TX (US)

Correspondence Address: BRACEWELL & GIULIANI LLP, P.O. BOX 61389, HOUSTON, TX, 77208-1389, US

(73) Assignee: EnviroFuels LLC, Houston, TX (US)

(21) Appl. No.: 11/800,738

(22) Filed: May 7, 2007

Related U.S. Application Data
(60) Provisional application No. 60/797,880, filed on May 5, 2006.

(51) Int. Cl. E21B 43/26; C09K 8/68

(52) U.S. Cl. 166/308.3; 166/308.2; 507/267; 507/276; 507/922

(57) ABSTRACT

The present invention relates to the field of additives to enhance hydraulic fracturing used in the production of oil and gas. The additive is an inorganic nitrogen and phosphorus-containing composition that can be added to, or used in conjunction with aqueous or non-aqueous hydraulic fracturing fluids or fracturing fluid adjunctives.

### RELATED APPLICATIONS

This application is related to and claims priority and benefit of U.S. Provisional Patent Application Ser. No. 60/797,880, filed May 5, 2006, titled “Improved Fracturing Fluids for Use in Oil and Gas Recovery Operations,” which is incorporated herein by reference in its entirety.

### TECHNICAL FIELD OF THE INVENTION

The present invention relates to formulations containing inorganic phosphorus and nitrogen compounds for use in fracturing operations to improve oil and gas production.

### BACKGROUND OF THE INVENTION

Crude oil development and production in U.S. oil reservoirs can include up to three distinct phases: primary, secondary, and tertiary (or enhanced) recovery.

During primary recovery, the natural pressure of the reservoir or gravity drive oil into the wellbore combined with artificial lift techniques (such as pumps) which bring the oil to the surface. But only about 10 percent of a reservoir's original oil in place is typically produced during primary recovery. Shortly after World War II, producers began to employ secondary recovery techniques, to extend the productive life of U.S. oil fields, often increasing ultimate recovery to 20 to 40 percent of the original oil in place. For the most part, these techniques have involved injecting water to displace oil and drive it to a production wellbore. In some cases, the reinjection of natural gas has been employed to maintain reservoir pressure (natural gas is often produced simultaneously with the oil from a reservoir).

However, as the well recovery reaches the 20-40 percent level, even secondary recovery becomes less efficient as the injected media takes the path of least resistance and begins to flow into the empty pores in the formation thus reducing the amount of oil and gas pushed through the formation to the wellhead.

As a result producers have attempted several tertiary or enhanced oil recovery (EOR) techniques that offer prospects for ultimately producing 30 to 60 percent, or sometimes more, of the reservoir's original oil in place. These techniques include thermal recovery (steam injection), chemical injection and gas (CO2) injection. However, EOR techniques can be relatively expensive and in some cases, the effectiveness is unpredictable.

Another method used to stimulate oil and gas production is hydraulic fracturing. Hydraulic fracturing is a technique used to allow oil and natural gas to move more easily from the formation and rock pores where they are trapped to a producing well that can then bring them to the surface. Hydraulic fracturing creates small cracks in the subsurface geologic formations.

The process involves pumping a fluid, usually a thickened or gelled water based fluid, into the oil and gas bearing formation. The pumping continues until the formation cracks or fractures. If only the base fracturing fluid were being pumped into the well, the fracture would close when the pumping operation stopped allowing the formation to return to its pre-fractured state. Therefore, in hydraulic fracturing operations, the fluid pumped into the well must contain a proppant, typically sand, which collects inside the fracture and prevents it from closing when the pumping has stopped. The oil and natural gas, trapped in the formation, can now permeate through the sand and travel to the wellhead to be pumped to the surface.

Hydraulic fractures can typically extend up to 1,000 feet from the wellbore in two separate lateral directions with the total length of the fracture reaching 2,000 feet. Carrying the proppant this distance without premature settling normally requires a viscous fluid capable of maintaining the proppant in suspension. Guar gum is commonly used to thicken the fracturing water to improve the proppant suspension ability. Other synthetic and natural thickeners or gelling agents have also been used.

Once the fracturing has been completed the viscous fracturing fluid must be removed from the well. If the fluid is not removed it can impede or block the permeation of the oil and gas through fractured formation. Fracturing fluids are designed to breakdown after the job has been completed such that the resulting viscosity is low and the fluid can easily pass through the propped fracture and produced to the surface. The only material that is intended to remain in the fracture is the proppant.

In actual practice the fracturing process can involve several stages which include prepad, pad, proppant-laden fracturing and flush.

In the prepad stage low viscosity base fluids like oil, water or foam, with low concentrations of additives, are pumped ahead of the main treatment. The low viscosity prepad formulations can more easily penetrate the rock matrix and initiate fracturing. The prepad also serves to reduce the formation temperature so as not to degrade the thickened or gelled main fracturing fluid. Prepad treatment formulations can also include friction-reducing agents and fluid loss additives.

In the pad stage the viscous fracturing fluid, without proppant, is pumped into the well to generate fracture length and width and to prepare the fracture for the proppant laden stages.

Proppant transporting stages continue the fracturing process and carry proppant into the formation. Maximum proppant concentrations depend on formation and fracturing fluid characteristics.

In the flush stage, less viscous base fluids, with low friction loss characteristics are used to displace the proppant laden fluid stages from the formation to the wellhead where they can be removed and recovered.

Low permeability reservoirs typically require extended-length fractures to maximize the surface area of the fracture faces and therefore improve production volumes and rates. Conventional fracture jobs achieve this fracture extension by pumping large volumes of propping agents at high concentrations in viscous gelled-fluid systems. This has several disadvantages including expense, poor stability of the highly gelled and thickened systems and sensitivity of the thickened and gelled systems to formation conditions, especially temperature, salts contamination and pH. Also, these highly viscous systems are difficult to flush from the formation and the residue left in the formation can decrease oil and gas production.

Low viscosity water fracturing is an alternative for fracturing low permeability formations that is substantially less expensive than conventional processes. A typical modern water fracturing process involves pumping very large volumes of fresh water with relatively low sand concentrations. The water is only lightly additized so the expense and clean-up problems sometimes experienced with conventional treatments are minimized. This type of water fracturing tends to maximize the fracture length while minimizing fracture height.

Whatever the contributing mechanisms of the low viscosity water fracture process, the created fractures can have conductivity rivaling that of conventional (water gel with high proppant concentrations) treatments, especially in low permeability formations.

Usually two basic types of proppants are used in hydraulic fracturing processes. Sand is by far the most common and is the most economical. However, sand can have a significant affinity for the oil or gas to be produced and thus reduce productivity. This affinity, of the sand for the hydrocarbon product, can be reduced by coating the sand with an inert resin. This can be costly. High strength ceramic proppants are more inert but are also expensive.

What is needed is a fracturing fluid additive than can be added to any stage of the fracturing process, including prepad, pad, proppant-laden fracturing and flush, such that the efficiency of the fracturing process is improved.

The additive can also be used to pre-coat the proppant so as to make the proppant more inert to the oil and gas to be produced.

Efficiency can be measured as increased oil and gas production from a producing well and/or a reduction in the amount of energy required to produce the oil and gas from the well.

### SUMMARY OF THE INVENTION

The current invention includes use of mixtures of aqueous inorganic salt solutions or emulsions of the aqueous salt solutions with a carrier fluid or non-aqueous dispersions of the inorganic salts in a carrier fluid, such that the salts contain phosphorus and nitrogen can be used in to increase the effectiveness and/or efficiency of hydraulic fracturing used in the production of oil and gas. The present invention included an additive technology that can be used at any and all stages of the fracturing process and includes the method of using the additive in conjunction with hydraulic fracturing.

The invention includes an enhanced hydraulic fracturing fluid including a fracturing fluid additive and a fracturing fluid. The fracturing fluid additive includes a mixture of salts and a dispersion fluid. The mixture of salts include [Y]xH2PO4 and [Y]ₓ₊₁HPO4, where [Y] is a cation and x is greater than 0. [Y] does not have to be the same cation in both salt compounds, however, in one embodiment, [Y] is the same cation in both ions. The cationic portion of the salt components can be any cation, with potassium being a preferred cation. In this case, the preferred components would be KH2PO4, K2HPO4. Another group of preferred cations would be ammonium compounds, the alkali metals or Group 1A elements. When the additive is prepared using ammonium compounds, ammonium compounds being defined as those compounds containing NHx groups, the nitrogen in the solution is essentially all in the form of ammonium ions. There is at most a negligible amount of free ammonia. The dispersion fluid is selected such that it is operable to maintain the salts within the dispersion fluid in at least a partially dispersed state. The fracturing fluid additive of the invention is operable to enhance hydraulic fracturing when added to the fracturing fluid. In an alternative embodiment, the fracturing fluid additive also includes [NH4]H2PO4 and [NH4]2HPO4. In a preferred embodiment and in addition to the phosphoric acid derived anions, the fracturing fluid additive also includes an organic acid anion, preferably containing 5 or fewer carbon atoms. One exemplary organic acid anion is acetate. Acetate is the anion of the salt or ester of acetic acid. In a preferred embodiment, the pH of the enhanced hydraulic fracturing fluid is between about 6.0 and 8.0.

The salts are made in-situ by mixing of the corresponding acids and bases in an aqueous matrix so as to form an aqueous parent solution containing inorganic phosphorus and nitrogen. The water acts as a solvent. Other preferred parent solution solvents include alcohols.

One preferred embodiment includes adding the inorganic phosphorus and nitrogen compounds as preformed salts of phosphoric acid in the presence of water to create the phosphorus-containing parent solution as an aqueous parent solution. Other preferred parent solution solvents include alcohols.

The aqueous parent solution can also contain pre-formed salts of organic acids, again preferably lower organic acids with a carbon of 5 or less, most preferably acetic acid.

Preferred cations for the pre-formed salts are ammonium compounds, alkali metals and Group IA elements.

Another preferred embodiment of the phosphorus-containing parent solution includes the addition of [Y]xPO4 to the [Y]xH2PO4, and [Y]ₓ₊₁HPO4 and contained ammonium equivalents.

Another preferred embodiment of the phosphorus-containing parent solution includes the addition of [NH4]xPO4 to the [Y]xH2PO4, and [Y]ₓ₊₁HPO4 and contained ammonium equivalents

While orthophosphoric acids have been described, also called phosphoric acids, this includes pyrophosphoric acids, which are the condensed analogs of orthophosphoric acid. The difference being that, through the process to condense the orthophosphoric acid, the PO₄³⁻ becomes P₂O₇²⁻ or other condensed phosphates. Therefore, [Y]xH2PO4, and [Y]₊₁HPO4 are precursors to pyrophosphoric acids. The use of the pyrophosphoric and other condensed forms is therefore encompassed within the definition of the orthophosphate form.

Included in the invention is a process for improving the performance of hydraulic fracturing involving the steps of providing the additive described above, to a stage in the hydraulic fracturing process, in an amount effective to increase oil production

In one embodiment of the invention the additive is utilized by adding to it to the prepad fluid in proportions necessary to stimulate increased oil production. A preferred embodiment includes the addition of between about 0.1 to 40,000 ppm phosphorus and 0 to 40,000 ppm nitrogen to the fluid though the addition of the additive. The additive can be added as either a water parent solution, an emulsion of the parent solution in a non-aqueous carrier fluid or as particle dispersion in a non aqueous carrier fluid.

In another embodiment of the invention the additive is utilized by adding to the pad fluid in proportions necessary to stimulate increased oil production. A preferred embodiment includes the addition of between about 0.1 to 40,000 ppm phosphorus and 0 to 40,000 ppm nitrogen to the fluid though the addition of the additive. The additive can be added as either a water parent solution, an emulsion of the parent solution in a non-aqueous carrier fluid or as particle dispersion in a non aqueous carrier fluid.

In one embodiment of the invention, the enhanced fracturing fluid also includes a proppant that is brought into contact with the fracturing fluid additive. The fracturing fluid additive is added to the proppant laden fracturing fluid in proportions necessary to stimulate increased oil production. A preferred embodiment includes the addition of between about 0.1 to 40,000 ppm phosphorus and 0 to 40,000 ppm nitrogen to the fluid though the addition of the additive. The additive can be added as either an aqueous parent solution, an emulsion of the parent solution in a non-aqueous carrier fluid or as particle dispersion in a non aqueous carrier fluid.

A particularly preferred embodiment is the one in which the proppant laden fracturing fluid is a low viscosity aqueous fracturing fluid.

In another embodiment of the invention the additive is utilized by adding to the flush fluid, in proportions necessary to stimulate increased oil production. A preferred embodiment includes the addition of between about 0.1 to 40,000 ppm phosphorus and 0 to 40,000 ppm nitrogen to the fluid though the addition of the additive. The additive can be added as either a water parent solution, an emulsion of the parent solution in a non-aqueous carrier fluid or as particle dispersion in a non aqueous carrier fluid.

The fracturing fluid can include a variety of fluids useful as a fracturing fluid including prepad fluid, pad fluid, proppant-laden fluid, flush fluid or any combinations of the fluids such that the addition of the additive is effective in increasing oil and gas production.

The invention also includes a process for creating an enhanced fracturing fluid for oil and gas recovery including the step of adding an amount of a chemical addition composition effective to improve oil recovery to an aqueous fracturing fluid, the chemical addition composition comprising reaction products from combining reactants, the reactants including a source of phosphoric acid, an alkali metal hydroxide, ammonium hydroxide and water under conditions to create an exothermal reaction. In one embodiment, the chemical addition composition further includes mixing acetic acid with the reaction products or the reactants. This acts to adjust pH. While the acetic acid can combine with bases to modify pH, the acetic acid is largely non-participatory with the reactants.

In one embodiment of the invention, the chemical addition composition is created by (i) mixing;
(a) an alkali metal hydroxide to raise the pH of the solution above 12 to form an aqueous ammonium/alkali metal hydroxide; or
(b) a source of phosphoric acid to lower the pH of the solution to about 0 to form an acidic ammonium mixture.

The next step includes either combining the intermediate solution of step (i.a.) with the source of phosphoric acid; or the solution of (i.b.) with the hydroxide at a rate sufficient to create a highly exothermic reaction. This results in reactive NH2 groups being contained in solution during the formation of the chemical addition composition. Organic acids can be present during the exothermic reaction or added post reaction to adjust pH to desired range.

A composition of phosphoric acid, alkali metal hydroxide and a source of reactive NH2 groups has been explored in U.S. Pat. No. 5,540,788 for the creation of a metal conversion surface, the disclosure of the patent being incorporated herein by reference.

A particularly preferred embodiment is one in which the fracturing fluid is a low viscosity aqueous fracturing fluid.

In an alternate embodiment of the current invention, the chemical addition composition described above can be emulsified with a suitable non-aqueous carrier fluid. The emulsified hydrocarbon carrier fluid, containing phosphorus and nitrogen in the desired proportions, can be added to the any of the fluids used in hydraulic fracturing

In another alternate embodiment of the invention, the emulsified carrier fluid can be dehydrated to produce a non-aqueous carrier fluid dispersion containing the inorganic salts of nitrogen and phosphorus as stable dispersed particles.

In a further alternate embodiment of the invention, the aqueous parent solution, the emulsified carrier fluid or the hydrocarbon carrier fluid dispersion can be used to coat the proppant particles so as to reduce their interaction with the oil and gas and thus improve the diffusion and transport of the oil and gas through the proppant matrix.

In a still further alternate embodiment of the invention, the aqueous parent solution, the emulsified carrier fluid or the hydrocarbon carrier fluid dispersion containing inorganic phosphorus and nitrogen, in the proper proportions, can be added in conjunction with, or as solutions with, other chemicals used in the oil recovery process including drilling mud, drilling fluids, surfactants, secondary oil recovery chemicals and products and EOR chemicals and products.

In one embodiment, the enhanced fracturing fluid includes fracturing fluid that is an aqueous fracturing fluid.

In another embodiment, the phosphorus content of the enhanced fracturing fluid is in a range from about 0.1 to about 40,000 ppm by weight of the enhanced fracturing fluid. In a more particularly preferred embodiment, the phosphorus content of the enhanced fracturing fluid is in a range from about 1 to about 150 ppm by weight of the enhanced fracturing fluid. Similarly, a preferred embodiment includes the enhanced fracturing fluid having a nitrogen content of between about 0.1 to about 40,000 ppm by weight of the enhanced fracturing fluid. More preferably, the nitrogen content is between about 1 to about 700 ppm by weight of the enhanced fracturing fluid.

The invention includes a process for enhancing hydraulic fracturing for recovery of oil and gas including the steps of providing a fracturing fluid additive in an amount effective to enhance hydraulic fracturing when added to a fracturing fluid, preferably an aqueous fracturing fluid, as compared to hydraulic fracturing performed without the fracturing fluid additive. The fracturing fluid additive includes a mixture of salts and a dispersion fluid. The mixture of salts includes [Y]xH2PO4 ; and [Y]ₓ₊₁HPO4, wherein [Y] is a cation. The dispersion fluid is operable to maintain the salts within the dispersion fluid in at least a partially dispersed state. The fracturing fluid additive is mixed with fracturing fluid to produce enhanced fracturing fluid. The enhanced fracturing fluid is pumped into a well.

In one embodiment of the invention, the chemical addition composition also includes a carrier fluid capable of sustaining the reactant product in dispersal within the carrier fluid such than an emulsion is created. The carrier fluid is operable to create a particle dispersion with the reactant products such that the chemical addition composition is at least partially miscible with non-aqueous hydraulic fracturing fluid or a non-aqueous hydraulic fracturing fluid adjunctive.

### DETAILED DESCRIPTION

Although not limited to any particular theory or concept, the additive of the current invention is believed to function in one or more of several ways;
(a) Phosphorus and nitrogen containing fluids, both the aqueous and non-aqueous variations, can reduce the coefficient of friction of the metallic moving and contacting parts of the mechanical equipment. Reduction of the coefficient of friction can reduce the reduce energy requirements of the equipment and thus reduce energy consumption.
(b) The phosphorus and nitrogen containing fluids, both the aqueous and non-aqueous variations, can improve fluid flow dynamics in the piping and tubing used to carry the fluids such that energy requirements to move the fluids are reduced and energy consumption is thus reduced. This flow improvement can be related to friction reduction, among other factors
(c) The phosphorus and nitrogen containing fluids, both the aqueous and non-aqueous variations, can improve the flow dynamics of the fluids through the geologic formation thus reducing the energy requirements to move the fluid the formation. This flow improvement may be related to friction reduction between the fluid and the geologic formation, among other factors.
(d) The phosphorus and nitrogen containing fluids can reduce the affinity of the oil and gas for the geologic formation itself. Reduced geologic affinity results in increased oil and gas production.
(e) The phosphorus and nitrogen containing fluids can reduce the affinity of the oil and gas for proppant and improve permeability of the oil and gas through the proppant matrix.
(f) Reduced affinity of the oil and gas for the proppant can also be achieved by pre-treating the proppant with the phosphorus and nitrogen containing fluids of the invention.
(g) The phosphorus and nitrogen containing fluids can act as nutrients for indigenous subterranean microbes than can, with the proper nutrition, form a biomass that can plug pores in rock formations and strata and prevent oil and gas leakage or slippage from the fracture an increase flow of the oil and gas through the proppant matrix to the wellhead.
(h) Phosphorus and nitrogen can act as nutrients for other indigenous microbes which can produce bio-surfactants that reduce the affinity of the formation for the oil and thus allowing for increased oil production.

A preferred embodiment of the invention includes the use of the inorganic phosphorus and nitrogen containing fluids by direct mixing with fracturing fluids, both aqueous and non-aqueous fracturing fluids used in any stage of a hydraulic fracturing process

An important aspect of this embodiment is that it is accomplished without wellbore face blocking. Wellbore face blocking can prevent treatment chemicals from properly entering the formation.

Another aspect of the preferred embodiment is that the pH of the aqueous parent solution can be controlled to be near or at neutral. In this manner, the strong acidic formulations and their corrosive characteristics are avoided.

One example of a preferred formulation of the invention includes the following ratios: 1.597 mols KH2PO4, 0.693 mol K2HPO4, 0.315 mol [NH4]2HPO4 and water. The pH of the solution can be controlled through manipulation of the ratios of these components. By manipulating the ratios of the resulting H₂PO⁴⁻ and HPO₄²⁻ ions, the solution can be created in a preferred pH range of about 6.0 to about 8.0.

In a preferred embodiment, KH2PO4, K2HPO4, [NH4]H2PO4 [NH4]2HPO4 and water are created into the phosphorus containing parent solution. One example of a preferred embodiment is 0.3 wt % phosphorus in the solution which is added directly to the aqueous fracturing fluid or fracturing fluid adjunctive in a suitable manner. Upon addition of the solution, the resulting phosphorus content can be in the range of about 50 to 150 ppm by weight and nitrogen between about 400 and 700 ppm by weight. Higher or lower amounts may also be useful.

### EXAMPLE 1

An inorganic phosphorus and nitrogen containing aqueous parent solution was prepared by mixing glacial acetic, phosphoric acid and water. A separate aqueous solution of potassium hydroxide and ammonium hydroxide was also prepared. The aqueous base solution was then added to the acidic solution as rapidly as possible so as to generate a strong exotherm. After the exotherm had subsided the pH was adjusted with more acetic acid to a pH of about 7.0. The final weight ratio of the components was 0.25 phosphoric acid, 0.26 potassium hydroxide, 0.13 ammonium hydroxide, 0.06 acetic acid and 0.30 water. The resulting product of this reaction is useful as the chemical addition component to enhance aqueous hydraulic fracturing fluids. While the invention has been shown or described in only some of its forms, it should be apparent to those skilled in the art that it is not so limited, but is susceptible to various changes without departing from the scope of the invention. For example, [Y]xH2PO4, [Y]ₓ₊₁HPO4 also encompasses [Y]x[H2PO4]z, [Y]ₓ₊₁[HPO4]z where x and z are variable integers.

We claim:

1. An enhanced hydraulic fracturing fluid comprising:
a fracturing fluid additive comprising a mixture of salts and a dispersion fluid, the mixture of salts comprising:
[Y]xH2PO4; and
[Y]ₓ₊₁₋HPO4, wherein [Y] is a cation, the dispersion fluid being operable to maintain the salts within the dispersion fluid in at least a partially dispersed state, the fracturing fluid additive being operable to enhance hydraulic fracturing when added to the fracturing fluid; and
fracturing fluid.

2. The enhanced fracturing fluid of claim 1 wherein the fracturing fluid additive further comprises [NH4]H2PO4 and [NH4]2HPO4.

3. The enhanced fracturing fluid of claim 1 wherein the fracturing fluid additive further comprises an organic acid anion.

4. The enhanced fracturing fluid of claim 3 wherein the organic acid anion contain 5 or fewer carbon atoms.

5. The enhanced fracturing fluid of claim 3 wherein the organic acid anion is acetate.

6. The enhanced fracturing fluid of claim 1 wherein the pH of the enhanced hydraulic fracturing fluid is between about 6.0 and 8.0.

7. The enhanced fracturing fluid of claim 1 wherein the fracturing fluid is an aqueous fracturing fluid.

8. The enhanced fracturing fluid of claim 1 wherein phosphorus content of the enhanced fracturing fluid is in a range from about 0.1 to about 40,000 ppm by weight of the enhanced fracturing fluid.

9. The enhanced fracturing fluid of claim 1 wherein the phosphorus content of the enhanced fracturing fluid is in a range from about 1 to about 150 ppm by weight of the enhanced fracturing fluid.

10. The enhanced fracturing fluid of claim 1 wherein nitrogen content of the enhanced fracturing fluid is between about 0.1 to about 40,000 ppm by weight of the enhanced fracturing fluid.

11. The enhanced fracturing fluid of claim 1 wherein nitrogen content of the enhanced fracturing fluid is between about 1 to about 700 ppm by weight of the enhanced fracturing fluid.

12. The enhanced fracturing fluid of claim 1 further comprising a proppant that is brought into contact with the fracturing fluid additive.

13. A process for enhancing hydraulic fracturing for recovery of oil and gas comprising the steps of:
providing a fracturing fluid additive in an amount effective to enhance hydraulic fracturing when added to a fracturing fluid as compared to hydraulic fracturing performed without the fracturing fluid additive, the fracturing fluid additive comprising a mixture of salts and a dispersion fluid, the mixture of salts comprising:
[Y]xH2PO4; and
[Y]ₓ₊₁HPO4, wherein [Y] is a cation, the dispersion fluid being operable to maintain the salts within the dispersion fluid in at least a partially dispersed state;
Mixing the fracturing fluid additive with fracturing fluid to produce enhanced fracturing fluid;
pumping the enhanced fracturing fluid into a well.

14. A process for creating an enhanced fracturing fluid for oil and gas recovery comprising the step of:
adding an amount of a chemical addition composition effective to improve oil recovery to a fracturing fluid, the chemical addition composition comprising reaction products from combining reactants, the reactants including a source of phosphoric acid, an alkali metal hydroxide, ammonium hydroxide and water under conditions to create an exothermal reaction.

15. The process of claim 14 wherein the chemical addition composition further comprises mixing acetic acid with the reaction products or the reactants.

16. The process of claim 14 wherein the chemical addition composition further comprises a carrier fluid capable of sustaining the reactant product in dispersal within the carrier fluid such than an emulsion is created.

17. The process of claim 16 wherein the carrier fluid is operable to create a particle dispersion with the reactant products such that the chemical addition composition is at least partially miscible with non-aqueous hydraulic fracturing fluid or a non-aqueous hydraulic fracturing fluid adjunctive.
